(19) United States
(12) Patent Application Publication
(10) Pub. No.: US 2014/0293587 A1
(43) Pub. Date: Oct. 2, 2014

(54) HANDS FREE ADJUSTABLE ILLUMINATING DEVICE LOWER EXTREMITY RETAINER

(71) Applicant: MARK ANTHONY SUARKEO, WOODLAND HILLS, CA (US)

(72) Inventor: MARK ANTHONY SUARKEO, WOODLAND HILLS, CA (US)

(21) Appl. No.: 13/854,068

(22) Filed: Mar. 30, 2013

(51) Int. Cl. F21V 33/00

(52) U.S. Cl. CPC F21V 33/0004
USPC 362/103

(57) ABSTRACT

A hands free lower extremity illuminating device retainer used for illuminating a user's path, particularly while walking, jogging, running, hiking, or during any other activity that requires light. The lower extremity illuminating device retainer is comprised of a single pliable strap encircling a user's lower extremity, featuring an object retainer pocket (24) for retaining an illuminating device (26), which directs a beam of light along user's path allowing the user's hands to be free for manipulation.

### CROSS-REFERENCE TO RELATED APPLICATIONS

Not Applicable

### FEDERALLY SPONSORED RESEARCH

Not Applicable

### BACKGROUND OF THE INVENTION

1. Field of Invention

This invention relates to flashlights and flashlight retainers, specifically used while walking, jogging, running, hiking, or during any other activity that requires light.

2. Discussion of Prior Art

The flashlight was introduced in New York in 1898. That flashlight weighed more than six pounds and was considered a novel toy. Today's lightweight, powerful flashlights are significantly more convenient and useful, thanks to advancements in light bulbs, batteries, and controls.

There are countless types of flashlights on the market varying in different colors, sizes, and brightness. The majority of these flashlights are made to be handheld. The disadvantages of handheld flashlights are obvious.

The user must have the ability to grasp and hold onto a flashlight. This requires the use of one hand leaving the other hand free for use. This does not allow the user to grasp or hold onto an object securely with both hands.

The user cannot rely on both hands for any activity requiring bilateral hand manipulation. Thus, the user has a greater chance of dropping the flashlight and losing sight of a path.

With handheld flashlights, the user must point the flashlight beam in the direction they wish to illuminate. This requires the user to expend energy while positioning their arm in a proper position.

There are countless prior art inventors who have considered such disadvantages and have developed devices to solve them. However, the prior art reveals devices for tasks requiring hands free use for only upper extremity activities.

The following prior art reveals devices that are only practical for limited activities such as working on a car engine or a fuse box in the dark. They are also cumbersome, uncomfortable, and inefficient if used during certain activities.

U.S. Pat. No. 1,769,241 (Stephani, 1930) discloses a wrist attachment for flashlights that represents a flexible wristband tightly adjusted to the wrist by a standard buckle. Buckles are more difficult to don and are generally uncomfortable. The user must position their arm to point the flashlight beam in the direction he or she wishes to illuminate.

U.S. Pat. No. 3,112,889 (Marmo, 1963) discloses a wrist-supported flashlight provided with flexible metallic strips connected with a flashlight battery and light bulb. This device has superfluous materials and has added weight. The user must position their arm to point the flashlight beam in the direction he or she wishes to illuminate.

U.S. Pat. No. 4,788,631 (Fuller, 1988) discloses a wrist-mounted flashlight having a case with a lens having a red light section and a white light section. The user must position their arm to point the flashlight beam in the direction he or she wishes to illuminate.

U.S. Pat. No. 4,887,194, (Fields, 1989) discloses a headband with excessive bands of elastic for holding flashlights directed at a viewing area. This may be cumbersome and uncomfortable to wear during activities such as jogging or hiking The user must flex their head down in order to illuminate the path in front of them.

U.S. Pat. No. 4,970,631 (Marshall, 1990) discloses a headband device for holding flashlight. It includes a holding means and a support member to retain a generally cylindrical flashlight. This may be cumbersome and uncomfortable to wear during activities such as jogging or hiking The user must flex their head down in order to illuminate the path in front of them.

U.S. Pat. No. 5,034,862 (Liston, 1991) discloses a multi-position flashlight holder. It is comprised of a headband for use in retaining a flashlight above one ear of the user so as to allow the beam of the flashlight to shine approximately along the user's line of sight. This may be cumbersome and uncomfortable to wear during activities such as jogging or hiking The user must flex their head down in order to illuminate the path in front of them.

U.S. Pat. No. 5,154,506 (Leard, 1992) discloses a flashlight armband that encircles a forearm enabling the user to be hands free while engaged in upper extremity activities. The user must position their forearm to point the flashlight beam in the direction he or she wishes to illuminate.

U.S. Pat. No. 6,062,700 (Price, 2000) discloses a flashlight armband, which provides a platform for both holding and directing a beam of light from a flashlight as well as protection from blows, and knife attacks. The user must position their forearm to point the flashlight beam in the direction he or she wishes to illuminate.

To conclude, the prior art offers a variety of hands free illuminating devices and retainers.

The disadvantages of the prior art include discomfort, bulkiness, inefficiency, and required superfluous movements of the upper limb and cervical spine.

Forearm attachment flashlight retainers allow the user to maintain bilateral hand manipulation while performing tasks in the dark. However, the flashlight beam must be actively pointed in the direction that the user wishes to illuminate. This would not be efficient for a person who is walking or hiking in the dark. In order to illuminate the path, the user must point his or her arm down and in front toward the ground. Maintaining this position for a prolonged period of time would be tiring. This is a superfluous motion of the upper extremity and requires excessive energy.

Headband flashlight retainers also allow the user to maintain bilateral hand manipulation while performing tasks in the dark. This also would not be efficient for a user who is jogging, running, or hiking The user must flex their cervical spine in a downward position in order to light the path in front of him or her. This is a superfluous motion of the neck and may become tiring to maintain this position for a prolonged period of time. In addition, headband retainers are cumbersome and may be more uncomfortable to wear during certain activities such as running

3. Objects and Advantages

Accordingly, several objects and advantages of the hands free lower extremity flashlight retainer over the prior art include significantly enhanced comfort, elimination of material making it extremely lightweight, and having the function of illuminating a path or trail without the use of a user's hand or arms.

With today's new materials, a single pliable strap having adhering properties to Velcro may be used. This minimizes the use of materials, which makes the device significantly more comfortable and lighter weight.

The proper placement of the lower extremity flashlight retainer around the lower extremity conveniently positions the flashlight beam in a manner to illuminate the path that a user is walking, jogging, or running The user is not required to hold, position, and aim the flashlight beam to illuminate the path. This allows the user to have their hands free for use. For example, the user obtains the ability to carry objects securely and safely.

Also, the user simply has his or her hands free for stabilization if a trip and fall were to occur. With handheld flashlights, the user is restricted to have only one hand free for use. Another object of this device includes extreme simplicity of donning and doffing. A single suspensor strap used in conjunction with Velcro materials is utilized for securing the device in place.

Similar to headlights on a vehicle, a person may use this device to illuminate the path or trail that he or she is walking, jogging, or hiking on. This not only benefits the user, but it also makes other people or drivers aware of the user if he or she was jogging at night. It may potentially save many victims from being struck by a driver who simply did not see a jogger because it was dark. This device may potentially save many lives.

Further objects and advantages of the hands free lower extremity flashlight retainer will become apparent from a consideration of the drawings and ensuing description.

### SUMMARY

This device relates to flashlight retainers, specifically used for people who walk, jog, run, and hike or is involved in any other activity in the dark. The device is secured on a user's lower extremity, which includes a pocket or a retainer that is set in a generally horizontal position. When worn properly, the pocket retains a generally thin illuminating device aligned to illuminate a user's path allowing the user's hands to be free for manipulation.

### DRAWINGS FIGURES

FIG. 1 is a perspective view of a hands free adjustable illuminating device lower extremity retainer of the present invention.

FIG. 2 is a side view of the exterior side of a hands free adjustable illuminating device lower extremity retainer of the present invention.

FIG. 3 is a side view of the interior side of a hands free adjustable illuminating device lower extremity retainer of the present invention.

### DETAILED DESCRIPTION OF THE PREFERRED EMBODIMENT

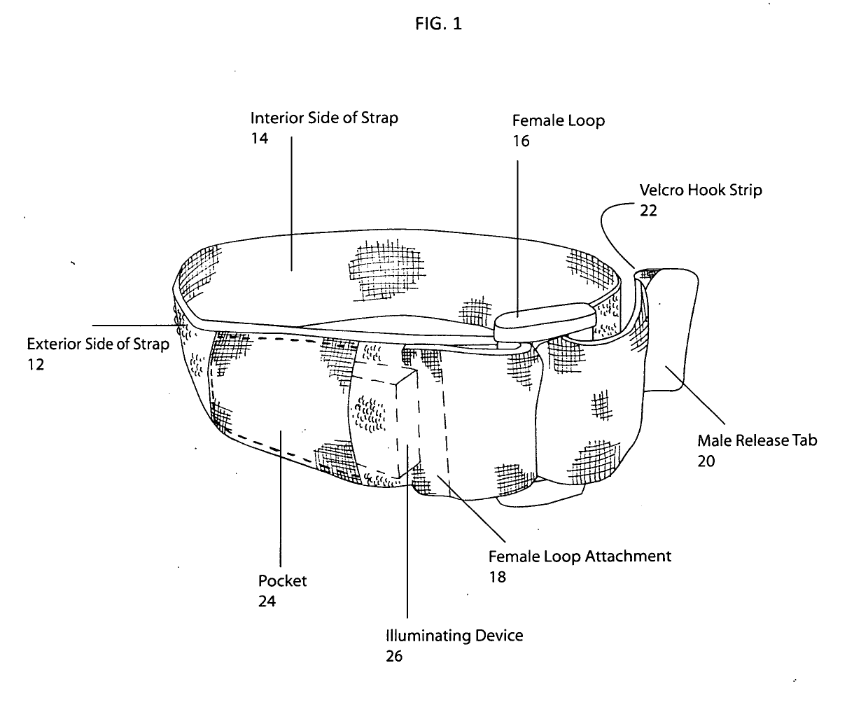

FIG. 1 depicts a perspective view of a hands free adjustable illuminating device lower extremity retainer. The hands free device consists of exterior side of strap 12 and interior side of strap 14. Attached at one end of the hands free device is encircling suspensor female loop 16 secured by encircling suspensor female loop attachment 18. On the opposite end of the hands free device is male release tab 20 with Velcro hook strip 22 attached adjacent to it along exterior side of strap 12.

Attached along exterior side of strap 12 in a generally horizontal position is object retainer pocket 24, which retains generally flat illuminating device 26.

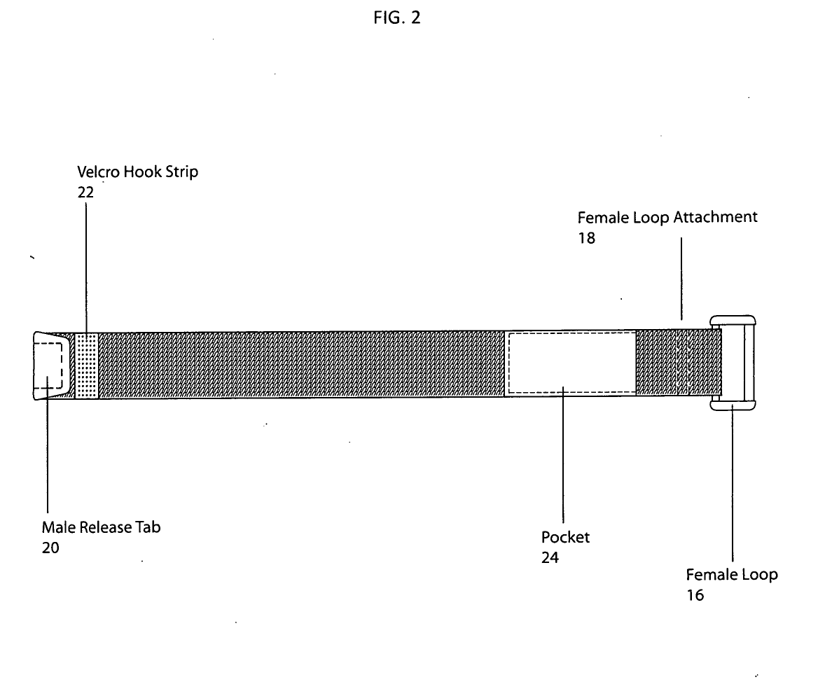

FIG. 2 depicts a side view of exterior side of strap 12 of a hands free adjustable illuminating device lower extremity retainer. On one end of the hands free device is encircling suspensor female loop 16 secured by encircling suspensor female loop attachment 18. On the opposite end of the hands free device is male release tab 20 with Velcro hook strip 22 attached adjacent to it along exterior side of strap 12. Object retainer pocket 24 retains generally flat illuminating device 26.

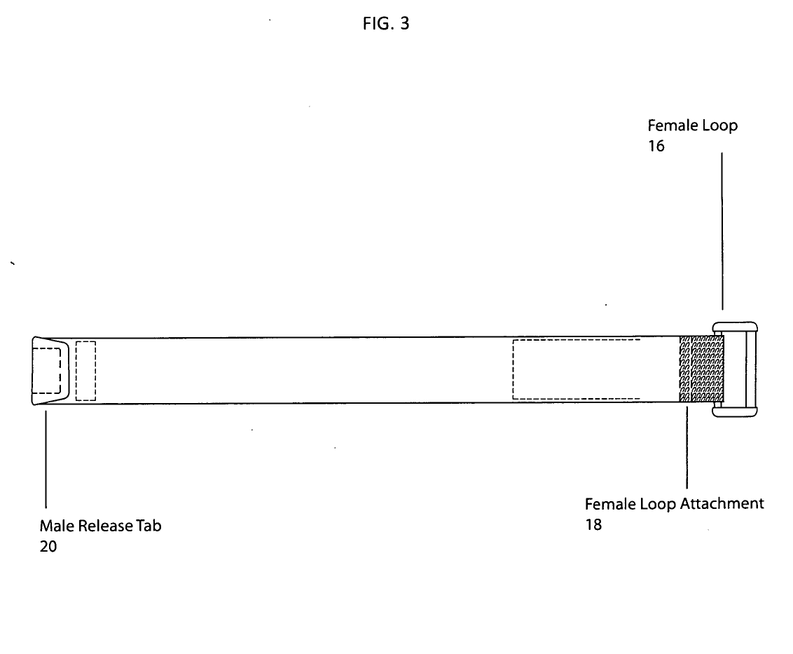

FIG. 3 depicts a side view of interior side of strap 14 of a hands free adjustable illuminating device lower extremity retainer. On one end of the hands free device is encircling suspensor female loop 16 secured by encircling suspensor female loop attachment 18. On the opposite end of the hands free device is male release tab 20.

### Operation—FIGS. 1-3

Use of the hands free adjustable illuminating device lower extremity retainer is extremely simple, comfortable, efficient, and does not require the use of one's hands for suspension and flashlight beam placement. To don, the user simply wraps interior side of strap 14 against his or her lower extremity by feeding male release tab 20 through encircling suspensor female loop 16 and back onto exterior side of strap 12 being attached and held by a single strip of Velcro hook strip 22. Interior side of strap 14 is held securely against the user's lower extremity.

The hands free device has sufficient tension against the user's lower extremity maintaining suspension and proper placement of illuminating device 26.

Object retainer pocket 24 and illuminating device 26 are generally positioned along the lateral portion of the user's lower extremity thus avoiding contact with the contralateral limb. This generally points illuminating device 26 in a relatively forward direction lighting a user's path. Object retainer pocket 24 retains illuminating device 26 securely against the user's body preventing excessive movement of a flashlight beam.

The hands free adjustable illuminating device lower extremity retainer may be worn on bilateral sides thus maximizing the amount of light and visibility of the path or trail. The device may be worn generally superior to the patella or generally inferior to the patella.

The device's pliable suspensor strap allows the adherence of Velcro hook and Velcro loop, which essentially decreases the overall weight of the device and increases user's comfort and acceptance.

The use of a single pliable strap having adhering properties to Velcro materials make this device extremely simple to don and doff.

The hands free adjustable illuminating device lower extremity retainer allows the user to do unlimited activities in the dark without the requirement of carrying a flashlight. This eliminates the risk of dropping and breaking a handheld flashlight. It also allows the user to have his or her hands free for manipulation. Whether a user is walking a dog in his or her neighborhood after dinner or hiking in the mountains at night, this device is practical for anybody to use.

Similar to headlights on a motor vehicle, a person may use this device to illuminate the path or trail that he or she is walking, jogging, or hiking on. This not only benefits the user, but it also makes other people or drivers aware of the user if he or she was jogging at night. It may potentially save many victims from being struck by a driver who simply did not see a jogger because it was dark. This device may potentially save many lives.

1. A hands free lower extremity illuminating device retainer for illuminating a user's path, comprising, in combination:
a single suspensor strap having a predetermined length according to said user's lower extremity size, said suspensor strap having an encircling suspensor loop attached at one end allowing a release tab on opposite end of said securing strap to be passed through said suspensor loop and attached directly back onto said suspensor strap whereby suspending said suspensor strap by means for joining said release tab to said securing strap, said securing strap having a generally horizontally aligned open-ended object retainer pocket as a means for retaining an illuminating device whereby directing a beam of light in said user's path.

2. The device in claim 1 wherein said single securing strap is made of materials with pliable characteristics.

3. The device in claim 1 wherein said single securing strap is a means for providing suspension and attachment encircling said user's lower extremity.

4. The device in claim 1 wherein said securing strap having an exterior side and interior side.

5. The device in claim 1 wherein object retainer is located on said exterior side of said securing strap and is positioned on medial or lateral side of said user's lower extremity whereby avoiding contact with said user's contralateral lower extremity.
